(19) United States
(12) Patent Application Publication
(10) Pub. No.: US 2006/0059471 A1
(43) Pub. Date: Mar. 16, 2006

(54) Calling non-public types

(75) Inventor: Vitali V. Prokopenko, Bellevue, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/941,400

(22) Filed: Sep. 15, 2004

(51) Int. Cl. G06F 9/44

(52) U.S. Cl. 717/130; 717/108

(57) ABSTRACT

Systems and/or methods capable of enabling an object having a non-public type in an assembly of managed code to be called as if the object's type is public are described. These systems and/or methods can generate a public proxy type with associated code that is capable of calling members of a non-public type. With this public proxy type and associated code, a software application can call members of the non-public type as if the original type were public.

### TECHNICAL FIELD

This invention relates to systems and methods for calling types.

### BACKGROUND

Many software products sold today are written in managed code. With managed code, such as Microsoft's®.net™ product, as well as other non-Microsoft® products such as Java™, a software product can be made up of a hierarchical arrangement of software objects. One of the advantages of creating a software product with objects is that often each of the objects can be individually tested. This aids developers of the software product by enabling them to test objects, or “units”, of the software product, which is often simpler than testing the whole software product.

A software product written in the “.net” managed code, for instance, can have definitions, such as “classes.” These classes can contain members, such as “methods,” “data components,” and “events.” Each of these classes can be public or non-public. If the class is public, the class members often can easily be called by other software, such as testing software. Referring to FIG. 1, a software product that has been compiled into a production assembly 100 having classes, each of which contains methods, is shown. First class 102 (marked “1^{st} Class (public)”) contains two methods, first method 104 (marked “M1 (pub)”) and second method 106 (marked “M2 (pub)”). Second class 108 (marked “2^{nd} Class (public)”) contains three methods, third method 110 (marked “M3 (pub)”), fourth method 112 (marked “M4 (pub)”), and fifth method 114 (marked “M5 (pub)”). All of these classes and methods have public types.

FIG. 1 also shows a universal testing framework 116 and a testing assembly 118. The universal testing framework is a generally accepted framework by which a particular type of managed code can be tested. The universal testing framework can call the testing assembly to test objects of types in production assembly 100. The testing assembly is a compiled assembly of a unit testing program. This unit testing program is written to test objects of various public types and their members of a software product. The illustrated unit testing assembly is capable of testing second method 106 of first class 102. This unit testing assembly can test the second method by calling the second method and sending input to the second method. The second method can then receive the input, perform actions on that input, and generate an output. The output can then be received by the testing assembly.

The testing assembly can send information to the universal testing framework based on the output received. This information can include a determination that second method 106 passed or failed, and other information about how the second method performed. The universal testing framework can present this information to a developer in an easy-to-analyze format.

Testing objects with non-public types, however, is often more difficult. It is more difficult because unit testing programs often cannot test objects with non-public types by calling them directly.

To partially address this problem, an object having a non-public type can be tested by writing testing code directly into the production assembly 100. This partial solution, while it allows access to—and thus testing of—objects of non-public types, has various problems. First, in many cases developers want to keep this testing code confidential. If the testing code is written in the production assembly, it can be read by a user that later buys the software program. Second, the testing code wastes a user's computer memory; it takes up memory that is not needed by a user who purchases the software product. Third, the testing code can confuse users and developers when included within the software product.

Another partial solution to this problem is to create a specialized non-production assembly of that part of the software program having the object of the non-public type to be tested. This partial solution, however, is often not sufficiently reliable because it may behave differently than an actual production assembly.

### SUMMARY

Systems and/or methods are disclosed that are capable of enabling members of a non-public type to be called by calling members of a public type.

### BRIEF DESCRIPTION OF THE DRAWINGS

FIG. 1 shows a prior-art production assembly of managed code, testing assembly, and universal testing framework.

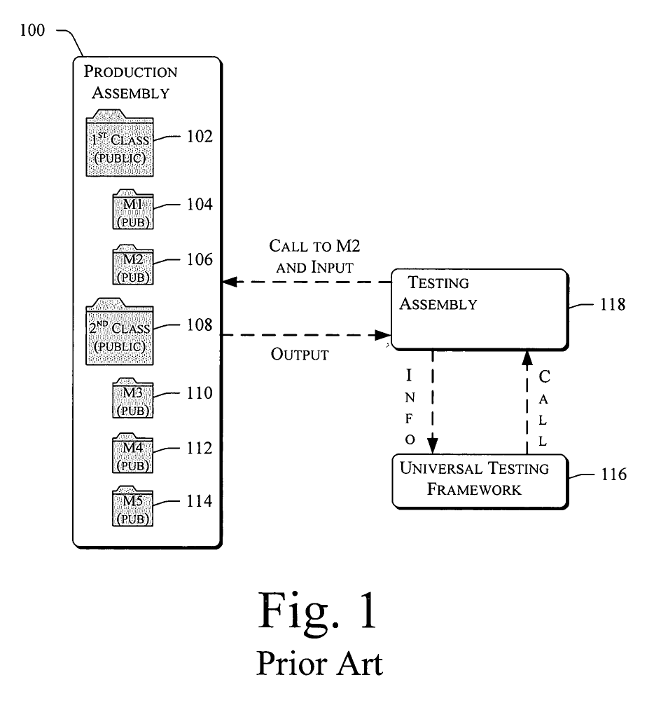

FIG. 2 illustrates a production assembly, proxy generator, and proxy assembly.

FIG. 3 sets forth a flow diagram of an exemplary process for enabling an object having a non-public type to be called as if the object's type is public.

FIG. 4 sets forth a flow diagram of an exemplary process for enabling unit testing of an object having a non-public type.

The same numbers are used throughout the disclosure and figures to reference like components and features.

### DETAILED DESCRIPTION

Overview

Systems and/or methods (“tools”) are described that enable an object having a non-public type in an assembly of managed code to be called as if the object's type is public. In one embodiment, for instance, the tools generate a public proxy with associated code that is capable of calling members of a non-public type. This public proxy and its associated code can be automatically generated by the tools using reflections from a production assembly having the non-public type.

By calling members of this public proxy, a software application can call the public proxy's corresponding members of a non-public type as if the non-public type is public. This enables a developer to more easily write software applications that need to call objects having non-public types. In one embodiment, the tools enable unit testing of an object having a non-public type as if the object instead has a public type.

Exemplary Proxy Generator and Assemblies

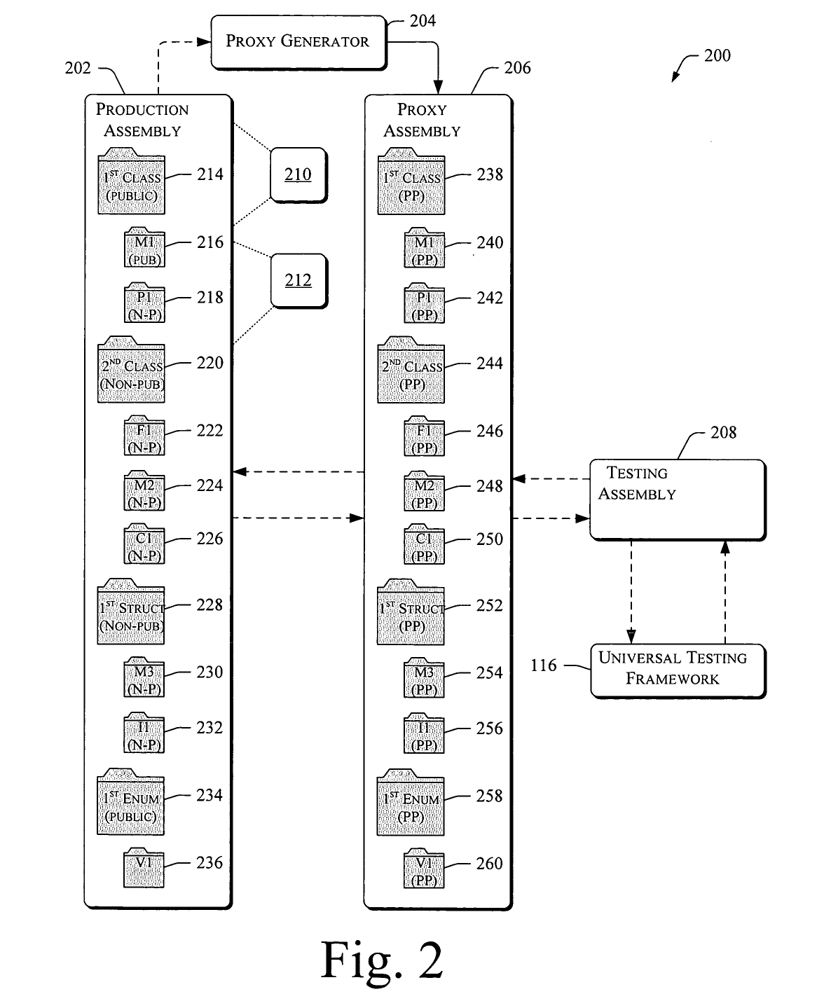

Referring to FIG. 2, an exemplary architecture 200 is shown having a production assembly 202, a proxy generator 204, a proxy assembly 206, a testing assembly 208, and a universal testing framework 116. This architecture 200 and its components are shown to aid in discussing, but are not intended to limit the applicability of, the tools.

In this exemplary architecture, production assembly 202 is a compiled assembly of a software product written at least in part using managed code. This managed code can comprise .net™, Java™, and other languages that enable object-oriented programming and metadata. The production assembly is arranged hierarchically, having objects representing operations and/or code portions of the software product. The production assembly can have public or non-public types. The production assembly contains reflections 210 (also called “metadata”) and managed code 212. The reflections contain information about managed code 212 in the production assembly, such as class, method, and attribute definitions. The reflections can be used by the proxy generator to create the proxy assembly, which is explored in more detail below.

The production assembly is shown having numerous public or non-public types. In this example, the production assembly comprises: a first class 214 that is public containing a first method 216 with arguments having a public type and a first property 218 having a non-public type; a second class 220 that is a non-public type and containing a first field 222 having a non-public type, a second method 224 with arguments having a non-public type, and a first constructor 226 with arguments having a non-public type; a first structure (a.k.a., a “struct” in .net™) 228 that is non-public containing a third method 230 with arguments having a non-public type and a first indexer 232 having a non-public type; and a first enumerator (a.k.a., an “enum” in .net™) 234 that is public containing a first value 236.

Also in this exemplary architecture, proxy generator 204 comprises one or more computer-readable media that is capable of receiving or accessing a non-public type of a production assembly and creating a public proxy and associated code capable of calling that non-public type.

Communication between the components of the architecture is shown with dashed lines. Dotted lines indicate constituent parts of the production assembly. The solid line from the proxy generator to the proxy assembly shows generation by the proxy generator of the proxy assembly.

Generating a Public Proxy

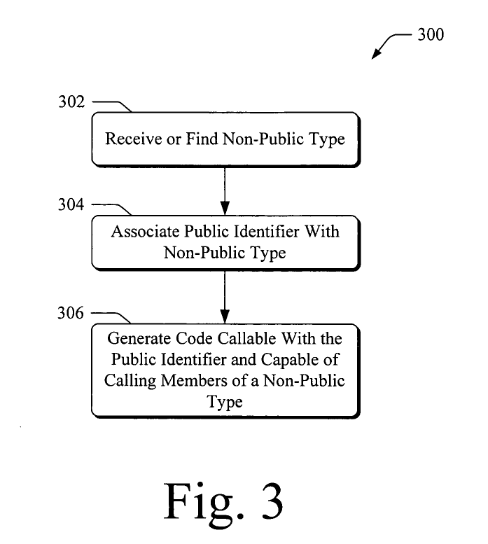

Referring to FIG. 3, an exemplary process 300 is shown for enabling an object having a non-public type to be called as if the object's type is public. This process is illustrated as a series of blocks representing individual operations or acts performed by proxy generator 204. This and other processes described herein may be implemented in any suitable hardware, software, firmware, or combination thereof. In the case of software and firmware, these processes represent sets of operations implemented as computer-executable instructions.

In process 300, proxy generator 204 enables an object having a non-public type to be called as if the object's type is public by generating a public proxy with associated code capable of calling members of the non-public type. This associated code can be effective to translate calls made to members of the public proxy into calls to the corresponding members of the non-public type. In the ongoing embodiment, the proxy generator automatically generates the public proxy and associated code, though in other embodiments human interaction can also be used.

Also in this process, components of architecture 200 are used as examples, such as production assembly 202. To aid the reader in understanding one way in which the proxy generator can generate public proxies and associated code, the production assembly comprises types written in .net™. Thus, while this production assembly contains types named “class,” “struct,” and “enum”, other names and types, like “structure” and “enumerator”, Java™ types, and the like can be handled by the proxy generator.

At block 302, proxy generator 204 receives or finds a non-public type. In one embodiment, the proxy generator accesses public and non-public types of an assembly and determines which are public and which are non-public. The proxy generator can, for instance, iteratively scan and pick out the following members of non-public types in production assembly 202: first property 218; second class 220; first field 222; second method 224; first constructor 226; first structure 228; third method 230; first indexer 232; and first value 236.

At block 304, the proxy generator associates an identifier with a particular non-public type. This identifier can comprise a public proxy that has members, which when called, can cause an operation to be initiated that calls members of the non-public type. The public proxy can comprise a namespace of the non-public type, which aids a developer in relating a public proxy to its non-public type.

In the ongoing embodiment, the proxy generator associates a namespace, for example “namespaceMicrosoft.ProxyTypes”, with the original namespace of the non-public type. Thus, if the original namespace for second method 224, for example, is “firstnamespace” the proxy generator can generate a new namespace of “namespaceMicrosoft.ProxyTypes.firstnamespace”. This new namespace can be used for proxy types.

At block 306, the proxy generator generates code that is callable with the public identifier and capable of calling members of a non-public type. In so doing, the code can translate calls made to the public identifier into calls to the members of the non-public type. To generate this code, the proxy generator can use metadata, such as reflections 210 (shown in FIG. 2) of production assembly 202. These reflections are a type of metadata that describe the production assembly and its types and their members, though other types of metadata that describe types and their members can also be used. The proxy generator can use metadata to find information about non-public types and the non-public types' members. This information permits the proxy generator to generate a definition for the corresponding proxy types and their members that is usable to permit calling of members of non-public types with a public identifier.

For non-public enumerator types, the proxy generator can generate code by writing “enum {name}”, where {name} is the non-public name of the type, iterate through values of the enumerator, and write those values into the proxy enumerator definition.

For non-public class (and similarly for structure) with types, such as second class 220, the proxy generator can generate code by writing “class {name}”, where {name} is the non-public name of the type and iterate through each of the members contained by the class. These members can include constructors, such as first constructor 226, methods, such as second method 224, properties, fields, such as first field 222, indexers, and events.

For each member contained by a class, the proxy generator can perform other actions to continue writing the code. For properties and fields, for instance, the proxy generator generates get-accessors and set-accessors. For indexers, the proxy generator generates these get- and set-accessors as following: a header that has the original (e.g., non-public) types translated to the corresponding public proxy types; code to unwrap input parameters to convert them to original types; code to invocate a corresponding indexer of the original type; and code to wrap returned value and output parameters of the original types to the corresponding proxy types and return them as an output. For constructors, such as first constructor 226, the proxy generator generates: a header that has original types of arguments translated to corresponding proxy types; code to unwrap input parameters; code to create an object using a constructor of the original type; and code to wrap the output parameters. The reference to the newly created object of the original type is also stored as part of the object of the proxy type. For a method, such as second method 224, the proxy generator generates: a header that has original types of parameters translated to corresponding proxy types; code to unwrap input parameters; code to invocate the original type; and code to wrap a return value and output parameters of the original types into the corresponding proxy types and return them as an output.

In the ongoing embodiment, the proxy generator generates code for each of the non-public types of the production assembly. If second method 224, for instance, is represented in the production assembly by:

```
namespace Sample
{
  using System;
  internal class Class2
  {
    internal void Method2
    (
      Class2 input,
      out Class2 output
    );
  }
}
```

The proxy generator generates the following code, which is associated with the public proxy for second method 224:

```
namespace Microsoft.ProxyTypes.Sample
{
  using System;
  using System.Reflection;
  public class Class2
  {
    public void Method2
      (
      Microsoft.ProxyTypes.Sample.Class2 input,
      out Microsoft.ProxyTypes.Sample.Class2 output
    )
    {
        object [ ] args = new object [2];
        args[0] =
          input != null ?
            input.GetOriginalObject( ) :
            null;
        args[1] = null;
        Type [ ] types = new Type [2];
        args[0] =
          Microsoft.ProxyTypes.Sample.Class2.
              GetOriginalType( );
        args[1] =
          Microsoft.ProxyTypes.Sample.Class2.
              GetOriginalType( );
        _type.GetMethod(“Method2”,types).
                Invoke(_object,args));
        output =
          Microsoft.ProxyTypes.Sample.Class1.
              Wrap(arg[1];
      }
      // The following are methods and definitions
      // generated by a proxy generator for proxy
      // classes. They are used by the members of
      // the proxy class, such as method2 above.
      public static Type GetOriginalType ( )
      { return _type; }
      public object GetOriginalObject ( )
      { return _object; }
      public static Class1 Wrap ( object o )
      { return new Class1 (new Ref(o)); }
      private struct Ref
      {
        public Ref ( object o ) { this.o = o; }
        public object o;
      }
      private Class1 ( Ref r )
      {
        _object = r.o;
      }
      private static Type RetrieveOriginalType ( )
      {
        Assembly productionAssembly = null;
        foreach (
          Assembly assembly
          in
          AppDomain.CurrentDomain.GetAssemblies( ) )
        {
          if (assembly.FullName==“SampleAssembly”)
          {
            productionAssembly = assembly;
            break;
          }
        }
        if (productionAssembly == null)
        {
          productionAssembly =
            Assembly.LoadFrom(“SampleAssembly.dll”);
        }
        return
        productionAssembly.GetType(“Sample.Class2”);
      }
      private static _type =
                RetrieveOriginalType( );
      private object _object = null;
    }
  }
```

The proxy generator can generate this code without user interaction for each non-public type in an assembly. With this code, a software developer can write simple, public calls into an application that are effective to call members of non-public types. In this example, rather than having to manually write the code immediately above to call second method 224, the developer can create objects of “namespaceMicrosoft.ProxyTypes.firstnamespace.secondclass” and call the second method.

In one implementation, the code generated by the proxy generator is built into an intermediary assembly. In the ongoing embodiment the proxy generator builds proxy assembly 206. Each non-public type of production assembly 202 is represented by a public proxy of the proxy assembly. Public types can also be represented in the proxy assembly, or they can instead by used directly from the production assembly. If the proxy assembly is to include public types, code associated with the public proxy for the public types can be included.

In the ongoing embodiment, the proxy assembly comprises members of the proxy types that can be called, which will in turn call the members of types in the production assembly. Each of the following members of the proxy types of the proxy assembly can, when called, call these listed members of the types of the production assembly: a first public proxy class 238 represents first class 214; a first method of public proxy 240 can call first method 216; a first property of public proxy 242 can call first property 218; a second public proxy class 244 represents second class 220; a first property of public proxy 246 can call first field 222; a second method of public proxy 248 can call second method 224; a first constructor 250 can call first constructor 226; a first public proxy structure 252 represents first structure 228; a third method of public proxy 254 can call third method 230; a first indexer of public proxy 256 can call first indexer 232; a first public proxy enumerator 258 represents first enumerator 234; and a first value of public proxy enumerator 260 represents first value 236.

If, by way of example, the public proxy of “namespaceMicrosoft.ProxyTypes.firstnamespace.secondclass” is called, the call is made to proxy assembly 206. This proxy assembly can then execute the code associated with the public proxy (shown above) to call and interact with the corresponding method of the non-public type in production assembly 202.

Unit Testing

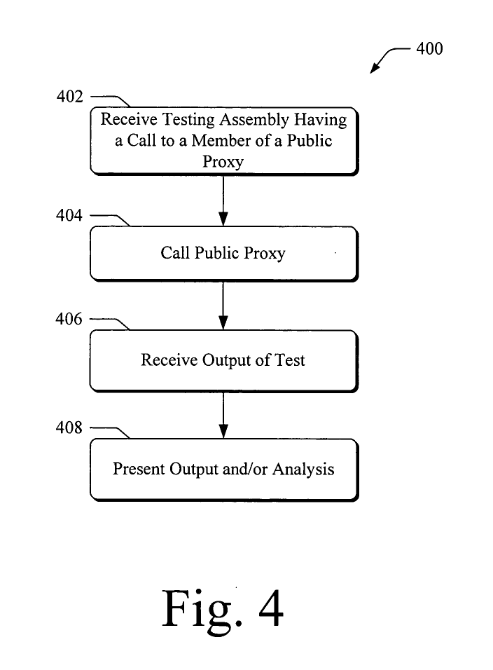

Referring to FIG. 4, an exemplary process 400 is shown that enables unit testing of an object having a non-public type as if the object instead had a public type. This process is illustrated as a series of blocks representing individual operations or acts performed by the architecture 200.

At block 402, a universal testing framework receives a testing assembly having a call to members of a public proxy. In one embodiment, the members of the public proxy contain code in proxy assembly 206. This code of the proxy assembly is capable of calling corresponding members of a non-public type in production assembly 202.

At block 404, the universal testing framework calls the public proxy, in this case by executing the testing assembly as an argument. In one embodiment, calling a public proxy initiates code in the proxy assembly that calls (and inputs data to) a member of a non-public type in a production assembly. The input can be provided by the testing assembly and be designed to test the member.

In the ongoing embodiment, the universal testing framework executes the testing assembly, thereby calling and sending testing data to the second method of the public proxy 248. By so doing, proxy assembly 206 executes calls and inputs testing data (as prescribed in the testing assembly) to second method 224 of production assembly 202. Second method 224 can be directed to receive this input, perform operations on the input, and provide output.

At block 406, the member of the public proxy type receives output. In the ongoing embodiment, the second method of the public proxy 248 receives output of the method 224, which it can send to the universal testing framework. This output and associated analysis can be received from or be a product of executing the testing assembly 208. Here the output is communicated from the production assembly to the proxy assembly. The proxy assembly then communicates this output to the testing assembly. The testing assembly analyzes this output and sends the output and/or its analysis to the universal testing framework.

At block 408, the universal testing framework presents the output and/or associated analysis. By so doing, a developer can be enabled to view and analyze the results in a user-friendly format.

### CONCLUSION

The above-described tools enable an object having a non-public type in an assembly of managed code to be called as if the object's type is public. These tools can also enable a non-public member of a public or non-public type to be called as if the member is public. Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method comprising:
associating a public identifier with a non-public type in an assembly of managed code; and
enabling members of the non-public type to be called by calling members of a public type identified by the public identifier.

2. The method of claim 1, wherein the act of enabling comprises:
generating code callable with the public identifier and capable of translating calls made with the public identifier into calls to the members of the non-public type.

3. The method of claim 2, wherein the public identifier comprises a public proxy namespace having a namespace of the non-public type.

4. The method of claim 2, wherein the act of generating comprises generating the code using reflections of the assembly.

5. The method of claim 2, wherein the act of generating comprises generating an intermediary assembly comprising the code.

6. The method of claim 1, further comprising building an intermediary assembly comprising code callable with the public identifier and capable of translating a call made with the public identifier into a call to the members of the non-public type.

7. The method of claim 1, wherein the act of enabling is performed without user interaction.

8. The method of claim 1, wherein the assembly of managed code comprises code written in .net™.

9. The method of claim 1, wherein the assembly of managed code comprises code written in Java™.

10. The method of claim 1, further comprising determining which types of the assembly of managed code are non-public.

11. A system comprising means for performing the method recited in claim 1.

12. One or more computer-readable media having computer-readable instructions for performing the method recited in claim 1.

13. One or more computer-readable media having embodied thereon an intermediary assembly of managed code having computer-readable instructions therein that, when executed by a computer, cause the computer to perform acts comprising:
receiving a call to a first object having a public type, the first object associated with a second object having a non-public type; and
responsive to receiving said call, calling the second object.

14. The intermediary assembly of claim 13, wherein the act of calling the second object comprises calling the second object from a production assembly having managed code.

15. The intermediary assembly of claim 13, further comprising:
receiving testing input intended for the second object;
communicating the testing input to the second object; and
receiving output from the second object.

16. The intermediary assembly of claim 15, further comprising:
communicating the output to a universal testing framework.

17. The intermediary assembly of claim 15, wherein the testing input is received from a unit testing assembly and further comprising communicating the output to the unit testing assembly.

18. A method comprising:
calling a member of a non-public type with a member of a public proxy;
communicating, directly or indirectly, input to the member of the non-public type designed to test the member of the non-public type; and
receiving output of one or more operations performed by the member of the non-public type using the input.

19. The method of claim 18, further comprising receiving a unit testing assembly capable of generating the input.

20. The method of claim 18, wherein the act of calling is performed by executing a unit testing assembly.

21. The method of claim 18, wherein the acts of calling, communicating, and receiving are performed using a universal testing framework.

22. The method of claim 18, further comprising presenting the output.

23. The method of claim 18, wherein the act of calling comprises calling a proxy assembly having code capable of translating the call effective to call the member of the non-public type.

24. The method of claim 18, wherein the act of calling is effective to execute code associated with the public proxy and capable of calling the member of the non-public type.

25. A system comprising means for performing the method recited in claim 18.

26. One or more computer-readable media having computer-readable instructions for performing the method recited in claim 18.
